(19) United States
(12) Patent Application Publication
(10) Pub. No.: US 2006/0130631 A1
(43) Pub. Date: Jun. 22, 2006

(54) Saw blade and a saw comprising the saw blade

(76) Inventors: Peter Hesselberg, Holbaek (DK); Robert Field, Munchen (DE); Manfred Geier, Puchheim (DE)

Correspondence Address: MOORE & VAN ALLEN PLLC, P.O. BOX 13706, Research Triangle Park, NC, 27709, US

(21) Appl. No.: 11/183,621

(22) Filed: Jul. 18, 2005

(30) Foreign Application Priority Data
Dec. 17, 2004 (DE) 10 2004 060 975.6

(51) Int. Cl. B23D 57/00; B27B 33/02

(52) U.S. Cl. 83/835; 83/846; 83/848

(57) ABSTRACT

A saw blade for rectilinear cutting motion, especially of a manually operated saw, comprising, at one longitudinal edge, at least a first section of a series of teeth formed at least at an end of the saw blade, and a second section of a series of teeth formed essentially in the middle of the saw blade, the tooth geometry, tooth configuration, tooth dimension, and/or the like of the first section of the tooth series differing from the tooth geometry, tooth configuration, tooth dimension, and/or the like of the second section of the tooth series in such a way that the cutting volume of a fixed number of teeth of the first section of the tooth series is smaller than the cutting volume of the same number of teeth of the second section of the tooth series.

The invention relates to a saw blade for rectilinear cutting motion, especially of a manually operated saw. At one longitudinal edge, such saw blades normally comprise a plurality of successive teeth of small cutting width, the tooth geometry being substantially constant along the series of teeth. The teeth usually are wedge-shaped and hardened. The sawdust produced by the cutting flanks of the teeth is received in chip spaces (the tooth gaps), thus being passed out of a resulting cutting groove.

When a saw is first applied to a workpiece, a problem is encountered as there is no cutting groove as yet during the first few movements of the saw. Therefore, the saw blade, if not handled with attention, often will lose its desired alignment with the article to be sawed despite the wrenching of the teeth in alternate directions. Even when workpieces are marked concentrated effort is required in applying the saw.

It is an object of the invention to provide a saw blade for rectilinear cutting motion, especially of a manually operated saw which, while overcoming the disadvantages of the prior art, offers easy application of the saw as well as starting of the sawing of workpieces while, at the same time, providing a great chip cutting volume.

This object is met by the features of claim 1.

At one longitudinal edge the saw blade thus comprises

at least a first section of a series of teeth provided at least at an end of the saw of the saw blade. Preferably, it may comprise a first section of a series of teeth at the free end of the saw blade mounted on a grip. At the grip-end face of the saw blade it may comprise another first section of a series of teeth. According to the invention, a second section of a series of teeth is provided as well. It is located substantially in the middle of the saw blade and may be contiguous to the first section or sections of tooth series. According to the invention, the tooth geometry, tooth configuration, tooth dimension, and/or the like of the first section or sections of the tooth series differ from the tooth geometry, tooth configuration, tooth dimension, and/or the like of the second section of the tooth series in such a way that the cutting volume of the first section of the tooth series especially is clearly smaller than the cutting volume of the second section of the tooth series. The cutting volume is understood to be the quantity of sawdust cut from a workpiece by a certain number of teeth, using the same workpiece material, the same environmental conditions, as well as the same actuating force and operating speed of a saw.

Preferably, the cutting volume of identical numbers of teeth of the first section of the tooth series is clearly smaller than that of the second section of the tooth series.

The saw blade according to the invention may be formed with first and second sections of tooth series at both longitudinal edges of the saw.

In a further development of the invention, the tooth pitch of the first section of the tooth series, as defined by the number of teeth per inch (25.4 mm) of saw blade length, is greater than the tooth pitch of the second section of the tooth series. Preferably the tooth pitch of the first section of the tooth series is distinctly greater than that of the second section of the tooth series. A preferred embodiment of the invention is to be provided, in the second section of the tooth series, with a coarse tooth pitch which may be defined by about nine teeth per inch, whereas a fine tooth pitch, defined by about twelve teeth per inch, may be provided for the first section of the tooth series.

Preferably, the tooth pitch of the first section of the tooth series is greater by at least one, two, three, or more than three teeth per inch than the tooth pitch of the second section of the tooth series. A particularly advantageous function is obtained with saw blades having a tooth pitch in the first section of the tooth series that is essentially one third greater than the tooth pitch of the second section of the tooth series.

Utilization ergonomy of the saw blade according to the invention is ideal if, at least at one end, the first section of the tooth series extends across at least one sixth of the total length of the saw blade.

The length of the second section of the tooth series preferably corresponds at least to three times the length of the first section of the tooth series when there is only one fine section of the tooth series, for example, at the free end of the saw blade. Where two fine sections of the tooth series are provided, one each at the ends of the saw blade, the length of the coarse section of the tooth series essentially corresponds to the length of both fine sections of the tooth series.

An alternative preferred embodiment has a smaller tooth height in the fine section of the tooth series than the tooth height in the coarse section of the tooth series, especially a clearly smaller height, preferably a height which is smaller by half.

The invention, moreover, relates to a saw comprising a saw blade according to the invention.

Other advantages, properties, and characteristics of the invention will become apparent from the description below of a preferred embodiment and from the accompanying drawing.

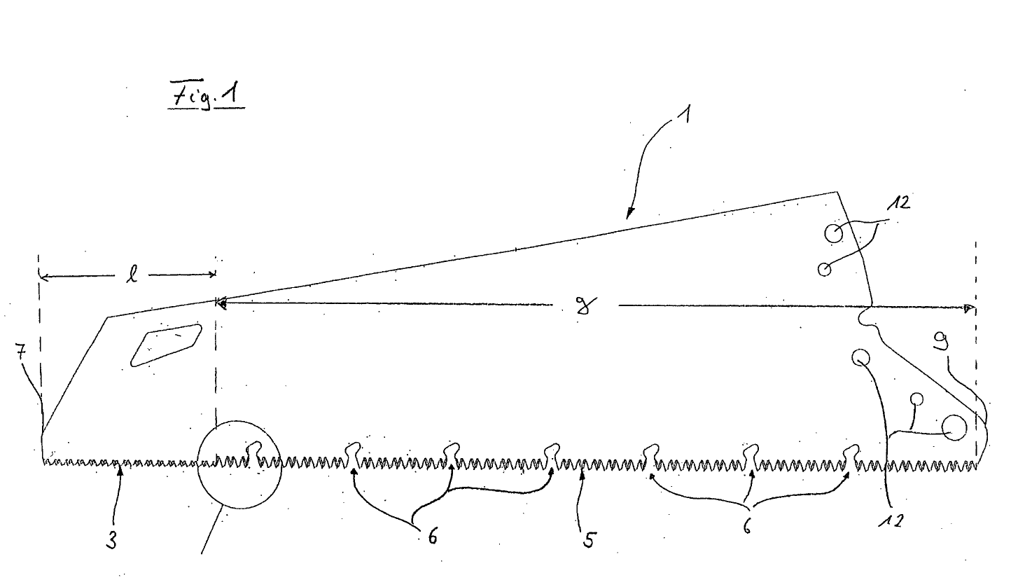

FIG. 1 is a side elevational view of a saw blade according to the invention.

The saw blade 1 according to the invention is designed for rectilinear alternating cutting motion and comprises two different sections 3 and 5 of series of teeth, at one longitudinal edge.

A fine section 3 of the tooth series extends from the free end 7 along the saw blade 1. The second, coarse section 5 of the tooth series extends from the fine section 3 of the tooth series to the grip-end face 9 of the saw blade 1. The coarse section 5 of the tooth series is interrupted by sawdust receiving recesses or gullets 6. FIG. 1 does not show a grip but instead only bores 12 which permit the saw blade 1 to be mounted, especially removably, on the grip.

The sections 3, 5 of the tooth series may be embodied by the most diverse tooth geometries and series arrangements, such as series of teeth wrenched in alternate directions or sinuous series of teeth. The fine section of the tooth series differs from the coarse section of the tooth series by having a smaller chip volume. That makes it easier for an operator, when first applying the saw, to generate the cutting groove as yet to be cut upon initial application of the saw. The operator merely has to engage the fine section 3 of the tooth series with the workpiece (not shown). Once a non-negligible cutting groove has been produced with the fine section 3 of the tooth series the coarse, central section 5 of the tooth series may be utilized for the actual separating process.

The smaller cutting volume at the smaller section of the tooth series is obtained by the provision of a tooth pitch of twelve teeth per inch (25.4 mm) across a marking length 1 from the free end 7 of the saw blade 1. A comparatively great cutting volume at the coarse section 5 of the tooth series is obtained by forming the coarse section of the tooth series with a tooth pitch of nine teeth per inch across the working length g of the saw blade 1.

It should be clear that a fine section of the tooth series may be formed also a the end 9 facing the grip, in particular essentially in correspondence with the length l, so that an ergonomically easy initial cut can be made both with the end 9 facing the grip and the free end 7. Moreover, series of teeth of different types may be provided at both longitudinal edges.

The features disclosed in the specification above, in the figures and claims may be significant for implementing the invention in its various embodiments, both individually and in any combination.

1. A saw blade for rectilinear cutting motion, especially of a manually operated saw, comprising, at one longitudinal edge, at least a first section of a series of teeth formed at least at an end of the saw blade, and a second section of a series of teeth formed essentially in the middle of the saw blade, the tooth geometry, tooth configuration, tooth dimension, and/or the like of the first section of the tooth series differing from the tooth geometry, tooth configuration, tooth dimension, and/or the like of the second section of the tooth series in such a way that the cutting volume of a fixed number of teeth of the first section of the tooth series is smaller than the cutting volume of the same number of teeth of the second section of the tooth series.

2. The saw blade as claimed in claim 1, wherein the tooth pitch of the first section of the tooth series is greater than the tooth pitch of the second section of the tooth series.

3. The saw blade as claimed in claim 2, wherein the tooth pitch of the first section of the tooth series is greater by at least one tooth per inch than the tooth pitch of the second section of the tooth series.

4. The saw blade as claimed in any claim 1, wherein the first section of the tooth series at least at one end of the saw blade extends across at least ⅙ of the total length of the saw blade.

5. The saw blade as claimed in claim 1, wherein the length of the second section of the tooth series corresponds to at least three times the length of the first section of the tooth series.

6. The saw blade as claimed in claim 1, wherein the tooth height of the first section of the tooth series is smaller than the tooth height of the second section of the tooth series.

7. A saw comprising a saw blade comprising, at one longitudinal edge, at least a first section of a series of teeth formed at least at an end of the saw blade, and a second section of a series of teeth formed essentially in the middle of the saw blade, the tooth geometry, tooth configuration, tooth dimension, and/or the like of the first section of the tooth series differing from the tooth geometry, tooth configuration, tooth dimension, and/or the like of the second section of the tooth series in such a way that the cutting volume of a fixed number of teeth of the first section of the tooth series is smaller than the cutting volume of the same number of teeth of the second section of the tooth series.

8. The saw blade as claimed in claim 2 wherein the tooth pitch of the first section of the tooth series is greater by at least two teeth per inch than the tooth pitch of the second section of the tooth series.

9. The saw blade as claimed in claim 2 wherein the tooth pitch of the first section of the tooth series is greater by at least three teeth per inch than the tooth pitch of the second section of the tooth series.

10. The saw blade as claimed in claim 2 wherein the tooth pitch of the first section of the tooth series is greater by one third than the tooth pitch of the second section of the tooth series.
